(19) United States
(12) Patent Application Publication
(10) Pub. No.: US 2005/0017503 A1
(43) Pub. Date: Jan. 27, 2005

(54) Connector with frangible seal

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/625,768

(22) Filed: Jul. 23, 2003

(51) Int. Cl. F16L 35/00

(52) U.S. Cl. 285/3

(57) ABSTRACT

The connector with frangible seal comprises of a tubular cylinder separated into two sections by a frangible seal. A first section has an inside diameter that will receive a first tubular member with an outside diameter approximately that of the inside diameter of a second tubular member received in the second section of the connector with frangible seal. When the two tubular members are urged toward each other the frangible seal separating the two tubular members will be fractured and the first tubular member will be inserted into the second tubular member and form a through path for fluids to move through them.

### BACKGROUND

1. Field of Invention

The present invention relates generally to a connector for connecting two tubular members. More specifically, the present invention relates to a connector for connecting two tubular members with a frangible seal separating the two tubular members.

2. Description of Related Art

Various designs for connectors for connecting hoses and tubes exist for joining two hoses or tubes. Generally, a connector is used to connect two hoses or tubes to allow formation of a longer hose or tube. A connector may also be used to allow a hose or tube to be separated into shorter sections or addition of adapters such as a Y-adapter or a nozzle.

Some connectors have a built-in valve that allows liquid flowing between the two connected hoses or tubes to be interrupted and controlled. However, these type of connectors are relatively complicated and expensive, particularly when compared to the innovative yet simple design of the present invention. Furthermore, none of the connectors allow insertion and sliding of one tube into another during use and also maintaining a seal between the two tubes, thus preventing fluid from one tube to enter the other tube, prior to actual application.

### SUMMARY OF THE INVENTION

The connector with frangible seal comprises of a tubular cylinder separated into two sections by a frangible seal. Preferably a first section has an inside diameter that will receive a first tubular member with an outside diameter approximately that of the inside diameter of a second tubular member received in the second section of the connector with frangible seal wherein when the two tubular members are urged toward each other the frangible seal separating the two tubular members will be fractured and the first tubular member will be inserted into the second tubular member forming a through path between the two tubular members.

### BRIEF DESCRIPTION OF THE DRAWINGS

FIG. 1 shows the preferred embodiment of the connector with frangible seal.

FIG. 2 shows the preferred embodiment of the connector with frangible seal after the frangible seal is fractured.

### DETAILED DESCRIPTION OF THE PREFERRED EMBODIMENT

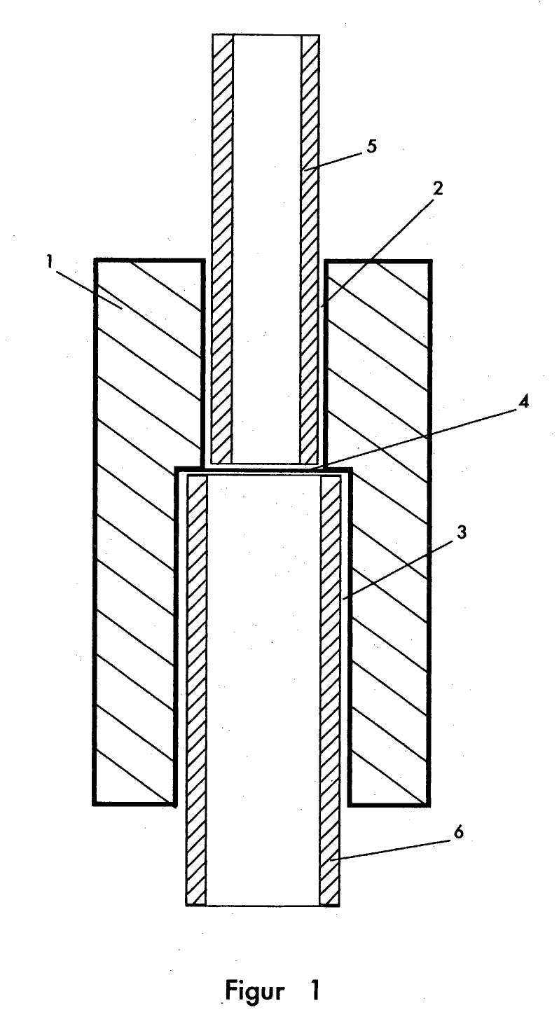

FIG. 1 shows the preferred embodiment of the present invention. In the preferred embodiment, the connector with frangible seal comprises of a tubular cylinder 1 separated into two sections 2, 3 by a frangible seal 4. Preferably a first section 2 has an inside diameter that will receive a first tubular member 5 with an outside diameter approximately that of the inside diameter of a second tubular member 6 received in the second section 3 of the connector with frangible seal wherein when the two tubular members 5, 6 are urged toward each other the frangible seal 4 separating the two tubular members 5, 6 will be broken and the first tubular member 5 will be inserted into the second tubular member 6 to allow a through path for fluid to move through the two tubular members 5, 6.

The tubular cylinder 1 may have a constant wall thickness in both the first section 2 and the second section 3. The tubular cylinder 1 may also have wall thickness of varying thickness such as that shown in FIG. 1 wherein the outside diameter of the tubular cylinder 1 is approximately constant throughout its length. The inside diameter of the tubular cylinder 1 may also taper from a larger diameter at each of the open ends toward a smaller diameter near the frangible seal 4.

Another embodiment of the connector with frangible seal may have a tubular cylinder 1 separated into two sections 2, 3 by a frangible seal 4 wherein a first section 2 has a section with reduced inside diameter that is slightly smaller than the outside diameter of the first tubular member 5 and a second section 3 has a section with reduced inside diameter that is slightly smaller that the outside diameter of the second tubular member 6 such that there is an interference fit between the tubular members 5, 6 and the tubular cylinder 1. Yet another embodiment of the connector with frangible seal may have a tubular cylinder 1 separated into two sections 2, 3 by a frangible seal 4 wherein a first section 2 has one or more protrusions on its inside diameter that will increase interference between the tubular cylinder 1 and the first tubular member 5 and retain the end of the first tubular member 5 within the tubular cylinder 1 and a second section 3 with one or more protrusions on its inside diameter that will increase interference between the tubular cylinder 1 and the first tubular member 5 and retain the end of the first tubular member 5 within the tubular cylinder 1.

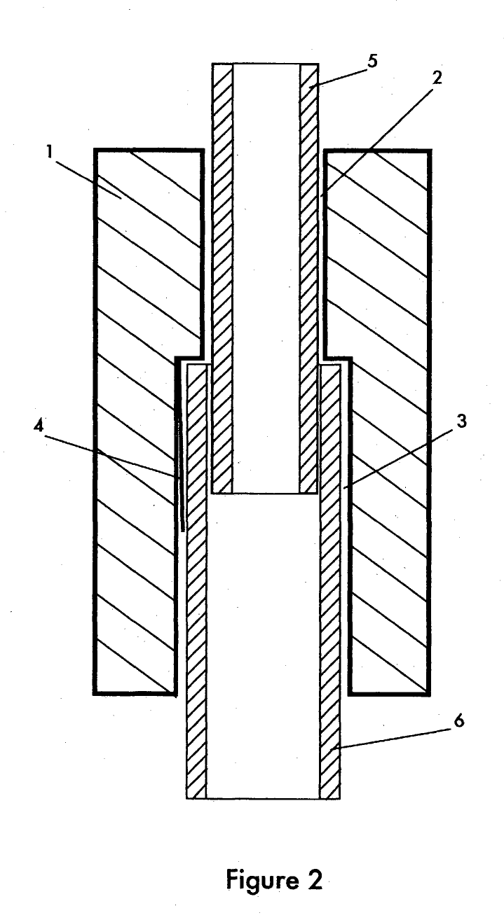

The frangible seal 4 may be a membrane separating the two sections 2, 3 of the tubular cylinder 1 and may be formed by the same material used to form the tubular cylinder 1. The frangible seal 4 is formed such that when the first tubular member 5 is urged toward the second tubular member 6 the frangible seal 4 will be fractured by the first tubular member 5 to allow the first tubular member 5 to slide into the second tubular member 6 and form a through path for fluids to move through them as shown in FIG. 2. The frangible seal 4 may also be formed by covering the end of one tubular member with a thin membrane and then inserting the end of the tubular member into the tubular cylinder 1 thereby forming the frangible seal 4 separating the tubular cylinder 1 into two sections 2, 3.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A connector with frangible seal comprising a tubular cylinder separated into a first section and a second section by a frangible seal wherein said first section has an inside diameter that will receive a first tubular member with an outside diameter approximately that of the inside diameter of a second tubular member received in said second section wherein when the two tubular members are urged toward each other the frangible seal separating the two tubular members will be fractured and the first tubular member will be inserted into the second tubular member.

2. A connector with frangible seal as in claim 1, wherein said frangible seal is a membrane formed from the same material as the tubular cylinder.

3. A connector with frangible seal as in claim 1, wherein said tubular cylinder has approximately constant wall thickness throughout its length.

4. A connector with frangible seal as in claim 1, wherein said first section of said tubular cylinder has a different wall thickness than said second section of said tubular cylinder.

5. A connector with frangible seal as in claim 1, wherein said first section has a larger diameter near a first end of the connector than near the frangible seal and wherein said second section has a larger diameter near a second end of the connector than near the frangible seal.

6. A connector with frangible seal as in claim 5, wherein said frangible seal is a membrane formed from the same material as the tubular cylinder.

7. A connector with frangible seal as in claim 1, wherein said first section has a reduced inside diameter section slightly smaller than the outside diameter of said first tubular member and wherein said second section has a reduced inside diameter section slightly smaller than the outside diameter of said second tubular member.

8. A connector with frangible seal as in claim 7, wherein said frangible seal is a membrane formed from the same material as the tubular cylinder.

9. A connector with frangible seal as in claim 1, wherein said first section has one or more protrusions on its inside diameter and wherein said second section has one or more protrusions on its inside diameter.

10. A connector with frangible seal as in claim 9, wherein said frangible seal is formed from the same material as the tubular cylinder.

11. A method of making a connector with frangible seal comprising the steps of:
covering a first end of a first tubular member with a thin membrane;
inserting said first end of said first tubular member into a first end of a tubular cylinder; and
inserting a second tubular member into a second end of said tubular cylinder;
whereby a frangible seal is formed that separates the tubular cylinder into two sections.
